(19) United States
(12) Patent Application Publication
(10) Pub. No.: US 2023/0397650 A1
(43) Pub. Date: Dec. 14, 2023

(54) CAPSULE WITH SUSCEPTOR PARTICLES AND CARRIER

(71) Applicant: Philip Morris Products S.A., Neuchatel (CH)

(72) Inventors: Rui Nuno Rodrigues Alves BATISTA, Morges (CH); Valerio OLIANA, Pully (CH)

(73) Assignee: Philip Morris Products S.A., Neuchatel (CH)

(21) Appl. No.: 18/256,128

(22) PCT Filed: Dec. 16, 2021
(86) PCT No.: PCT/EP2021/086073

§ 371 Date: Jun. 6, 2023

(30) Foreign Application Priority Data
Dec. 17, 2020 (EP) 20215042.1

(51) Int. Cl. A24B 15/28; A24F 40/465; A24F 40/10

(52) U.S. Cl. CPC A24B 15/283; A24F 40/465; A24F 40/10

(57) ABSTRACT

A capsule for an aerosol generating article is provided, the capsule including: an active agent; susceptor particles configured to be heatable upon inductive heating; and one or both of a carrier gel or a carrier liquid, the susceptor particles being dispersed in the one or both of the carrier gel or the carrier liquid, and the susceptor particles having a particle size of about 10 μm to 70 μm. An aerosol-generating article including the capsule is also provided. An aerosol-generating system is also provided, including: the aerosol-generating article; an aerosol-generating device; and an induction heating element. A method of operating the aerosol-generating system is also provided.

The present invention relates to a capsule for use in an aerosol generating article. The present invention further relates to an aerosol-generating article comprising the capsule. The present invention also provides an aerosol-generating system including the aerosol-generating article and a method of operating the aerosol-generating system.

Aerosol-generating devices are known which heat but which do not burn aerosol-forming substrates in aerosol-generating articles such as tobacco. Such devices heat the aerosol-forming substrates to a temperature sufficient to generate an aerosol for inhalation by the user. These aerosol-generating devices normally include an area for receiving the aerosol-forming substrates. These devices are typically portable, hand-held devices and are required to be compact.

The aerosol-forming articles normally contain an aerosol-forming substrate including an aerosol former and further substrate material such as tobacco, which includes volatile compounds for the formation of the aerosol. Some aerosol-forming articles also contain capsules including additional ingredients. These additional ingredients may be unstable ingredients that may be decomposed or evaporate prior to use, when not housed in the capsule. These capsules are normally broken by the user prior to use, which is laborious and which negatively affects the user experience. Furthermore, breaking the capsule by bending the aerosol-generating article might deform the aerosol-generating article also negatively affecting the air management inside the article. Other aerosol-generating devices include complicated mechanisms for breaking the capsules, often requiring additional user action.

It would be desirable to provide capsules which can be broken with less or no additional user's actions required except for the user inserting the aerosol-forming article into the aerosol-generating device. It would be desirable to provide capsules which can release the additional ingredients without requiring the application of additional force in excess of the force required to insert the aerosol-forming article into the aerosol-generating device.

According to an embodiment of the present invention a capsule for use in an aerosol generating article is provided. The capsule may comprise an active agent. The capsule may comprise susceptor particles. Furthermore, the capsule may comprise one or both of a carrier gel or a carrier liquid, wherein the susceptor particles are dispersed in one or both of the carrier gel or the carrier liquid. The capsule thus may comprise both a carrier gel and a carrier liquid. The capsule may comprise only a carrier gel or the capsule may comprise only a carrier liquid.

According to another embodiment of the present invention a capsule for use in an aerosol generating article is provided. The capsule comprises an active agent. Furthermore, the capsule comprises susceptor particles. The capsule also comprises one or both of the carrier gel or a carrier liquid. The susceptor particles are dispersed in one or both of the carrier gel or the carrier liquid. The capsule therefore comprises both a carrier gel and the carrier liquid. The capsule also may only comprise a carrier gel or the capsule may only comprise a carrier liquid.

The capsule may be received in an aerosol-generating device. The aerosol-generating device may include a heating element, in particular an inductive heating element, such as an inductive coil. Upon inductive heating of the capsule received in the aerosol-generating device, the susceptor particles may be heated by the alternating magnetic field of the inductive heating element. This may also heat the capsule. The heating of the capsule may at least partly liquefy any carrier gel being present in the capsule. The heating may also aid at least partly in a disintegration of the capsule. The heating also may decrease the viscosity of the carrier liquid. Upon heating, the susceptor particles may become movable if the carrier particles are dispersed in a carrier gel. Upon heating, the movement of the susceptor particles dispersed in a carrier liquid also may increase. The susceptor particles, which are also magnetic may agglomerate in the alternating magnetic field of the inductive heating element. The susceptor particles may form clusters aligning along the orientation of the magnetic field. The formation of the clusters and aggregates may be due to a magnetorheological effect of the magnetic susceptor particles in the alternating magnetic field. This may form channels where primarily the liquefied carrier gel or carrier liquid is present with the active agent. This magnetorheological effect may cause the susceptor particles to align along the lines of magnetic flux when the alternating magnetic field is applied. The susceptor particles may form a network of interconnected aggregates and clusters. The formation of clusters and aggregates of the susceptor particles may ease the formation of an aerosol including at least the active agent. The combination of heating of the capsule due to the inductive heating and the agglomeration and the formation of clusters due to the magnetorheological effect may enhance the release of the active agent from the capsule. This may allow the release of the active agent from the capsule without the need of applying any pressure, in particular mechanical pressure to the capsule.

In general, the susceptor particles comprise or are made of a material that is capable of generating heat, when penetrated by an alternating magnetic field. When located in an alternating magnetic field. If the susceptor particles are conductive, then typically eddy currents are induced by the alternating magnetic field. If the susceptor particles are magnetic, then typically another effect that contributes to the heating is commonly referred to hysteresis losses. Hysteresis losses occur mainly due to the movement of the magnetic domain blocks within the susceptor particles, because the magnetic orientation of these will align with the magnetic induction field, which alternates. Another effect contributing to the hysteresis loss is when the magnetic domains will grow or shrink within the susceptor particles. Commonly all these changes in the susceptor particles that happen on a nano-scale or below are referred to as “hysteresis losses”, because they produce heat in the susceptor particles. Hence, if the susceptor is both magnetic and electrically conductive, both hysteresis losses and the generation of eddy currents will contribute to the heating of the susceptor particles. If the susceptor particles are magnetic, but not conductive, then hysteresis losses will be the only means by which the susceptor will heat, when penetrated by an alternating magnetic field. According to the invention, the susceptor particles may be magnetic and electrically conductive. An alternating magnetic field generated by one or several induction coils heat the susceptor particles, which then transfers the heat to the other components of the capsule, the one or both of carrier gel or a carrier liquid and the active agent. This may facilitate the formation of an aerosol. The heat transfer may be mainly by conduction of heat.

One or both of the carrier gel or the carrier liquid may comprise one or more of:
at least one polyhydric alcohol,
at least one ester of a polyhydric alcohol, and
at least one aliphatic ester of a mono-, di- or polycarboxylic acid. These compounds may serve as the carrier for dispersion of the susceptor particles. These compounds also may serve as aerosol-formers. Upon heating the capsule, the compounds of the carrier gel or the carrier liquid may facilitate the formation of a dense and stable aerosol that may be substantially resistant to thermal degradation at the temperature of heating the capsule.

The carrier gel or the carrier liquid may comprise polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Particular preferred compounds may be polyhydric alcohols or mixtures thereof, such as triethylene glycol, 1,3-butanediol and glycerine. The carrier gel or carrier liquid may comprise propylene glycol. The aerosol former may comprise both glycerine and propylene glycol. Preferably, the carrier gel or carrier liquid may comprise glycerol.

The at least one polyhydric alcohol, at least one ester of a polyhydric alcohol, and at least one aliphatic ester of a mono-, di- or polycarboxylic acid may be present in an amount of 30 weight percent to 75 weight percent, more preferably 48 weight percent to 65 weight percent of the capsule. These weight percent ranges may be particularly suited in order for these compounds to serve as a carrier gel or as a carrier liquid for the dispersion of the susceptor particles.

Unless stated otherwise, term “weight percent” of a component of the capsule is the ratio of the mass of this component to the total mass of all components of the capsule.

The active agent may be dissolved or dispersed in the carrier gel or carrier liquid. This may ease the release of the active agent upon heating of the capsule. The one or more active agents may be uniformly dispersed in the carrier gel or carrier liquid in the capsule. This may greatly enhance the stability of the capsule. Any kind of agglomeration or formation of clusters only may occur upon applying an electric field to the capsule.

The carrier gel may comprise a gelling agent. The gelling agent may facilitate the gelling of a carrier liquid in order to produce the carrier gel of the capsule. A carrier gel thus may comprise a carrier liquid and gelling agent. The gelling agent may be one or both of the polysaccharide or a protein. The gelling agent may comprise one or more of natural gums, starches, pectins, alginates, carrageenan, agar and gelatin. The gelling agent may be present in an amount of 4 to 8 weight percent, preferably in an amount of 5 to 7 weight percent of the capsule.

The susceptor particles may be ferromagnetic. Ferromagnetic susceptor particles may particularly easy agglomerate and form clusters in a magnetic field. Ferromagnetic susceptor particles may exhibit a strong magnetorheological effect in a magnetic field. This may greatly enhance the formation of clusters and agglomerates of the susceptor particles. This also may enhance the formation of an aerosol upon heating of the capsule. The ferromagnetic susceptor particles may comprise or consist of a metal or metal oxide. The ferromagnetic susceptor particles may comprise one or more of iron, cobalt and nickel or the oxides thereof. Preferably, the susceptor particles may comprise or consist of Fe₂O₃.

The susceptor particles may have a particle size of about 10 to 70 micrometers, preferably of about 20 micrometers to 50 micrometers. These particle sizes may allow the formation of clusters or agglomerates in a magnetic field when the capsule is heated.

The susceptor particles may be present in an amount of 5 to 45 weight percent, preferably in an amount of 15 to 35 weight percent of the capsule. These weight percent ranges may allow susceptor particles to be disbursed in either one of the gel carrier or the liquid carrier. These weight percent ranges may also allow the agglomeration and the formation of clusters of the susceptor particles in the capsule upon heating the susceptor particles in an alternating magnetic field.

The capsule may further comprise fibers. The fibers may be present in an amount of weight percent to 17 weight percent, more preferably in an amount of 0.75 weight percent to 11 weight percent of the capsule. The fibers may stabilize the overall shape of the capsule. The fibers may comprise one or both of cellulose and cellulose derivatives.

The capsule may comprise one or more active agents. Using more than one active agent may lead to the formation of an aerosol including a plurality of active agents. The one or more active agents may be prone to react with atmospheric components, such as oxygen. The one or more active agents may be highly volatile and diffuse without containment. Containing these sensitive active agents in the capsule may prevent any deterioration of the active agents before the capsule is used.

The one or more active agents may comprise one or more of flavorants, nicotine and medications. For example, the one or more active agents may comprise flavorants oils. The one or more active agents may comprise one or more of mint oil, menthol, nicotine oil; coffee derivate flavorings, caffeine; guarana; taurine; glucuronolactone or other flavorants. The active agent may be present in an amount of 0.5 weight percent to 3 weight percent, more preferably in an amount of 0.75 weight percent to 3 weight percent of the capsule. The capsules may be used in order to convey pharmaceutically active ingredients as active agents to a user.

The capsule may furthermore comprise a C₃ to C₆ alkyl hydroxy carboxylic acid, preferably lactic acid. The C₃ to C₆ alkyl hydroxy carboxylic acid may increase the solubility of some components of the active agent, in particular nicotine in one or both of carrier gel and the carrier liquid. The C₃ to C₆ alkyl hydroxy carboxylic acid may protonate the nicotine, thereby increasing its solubility.

The capsule may comprise a shell. The shell may encapsulate the active agent, the susceptor particles and the one or both of a carrier gel or a carrier liquid. The shell may comprise a material that becomes fluid permeable upon heating. This may allow the release of the active agent and the gel carrier or the liquid carrier from the capsule. The shell may comprise polysaccharides, in particular cellulose. The shell may comprise solid polymeric material encapsulating one or both of the gel carrier or the liquid carrier including the active agent and the disbursed susceptor particles.

The capsule may comprise a shell including a flexible, gelatin film plasticized by the addition of glycerine, sorbitol, or a similar polyol. These capsules are also known as “soft gel capsules”.

Preferably, the capsule may comprise a carrier gel. If the capsule comprises a carrier gel, the carrier gel may be solid enough in order to provide a self-supporting capsule. In this case, the capsule may not need to contain an extra shell for encapsulating the carrier gel or carrier liquid together with the active agent and the susceptor particles. A self-supportive carrier gel may be formed by adding larger amounts of the gelling agent to carrier liquid. This may be done by adding between 6 to 8 weight % of the gelling agent of the capsule to the carrier liquid in order to induce the gelling of the carrier liquid.

The one or more breakable capsules may have a burst strength of about 0.5 kilogram force to 3.0 kilogram force, preferably of about 1.3 to 2.7 kilogram force, most preferably of about 1.9 to about 2.5 kilogram force.

The capsule may comprise a carrier liquid, wherein the carrier liquid and the susceptor particles may form a magnetorheological fluid. The susceptor particles of the magnetorheological fluid may particular easy form clusters and agglomerates upon heating of the capsules when an alternating magnetic field is applied.

Another embodiment of the invention may provide an aerosol-generating article comprising a capsule as described herein. The aerosol-generating article may comprise a capsule portion, which includes the capsule. The capsule portion may comprise one or more capsules as described herein. For example, the capsule portion may comprise two, three or at least four capsules. The capsule portion may comprise a retention material, wherein said capsule is located either adjacent to the retention material or may be embedded within the retention material. A hollow tubular portion may be present in capsule portion. The hollow tubular portion may comprise the retention material. The hollow tubular portion in the capsule portion may surround the capsule. The retention material may absorb the active agent and one or both of the gel carrier and the liquid carrier upon being released from the capsule. This may avoid any spillover of the components of the capsule out of the aerosol-generating article.

The retention material may comprise a fiber material. The retention material may comprise one or more of cellulose acetate fibre, paper, porous polymer and charcoal. The cellulose acetate fiber may be cellulose acetate tow. The porous polymer may be porous resins, such as a phenyl-formaldehyde resin. Preferably the retention material may comprise cellulose acetate.

The capsule portion of the aerosol-generating article may comprise a first filter element, which may be located upstream of capsule. The capsule portion also may comprise a second filter element, which may be located downstream of the capsule.

As used herein, the terms “upstream”, and “downstream”, are used to describe the relative positions of components, or portions of components, of the aerosol-generating article or the aerosol-generating device in relation to the direction in which air flows through the aerosol-generating article or aerosol-generating device during use thereof along the air flow path. Aerosol generating articles according to the invention comprise a proximal end through which, in use, an aerosol exits the device. The proximal end of the aerosol generating article may also be referred to as the mouth end or the downstream end. The mouth end is downstream of the distal end. The mouth end may comprise a mouthpiece. The distal end of the aerosol generating article may also be referred to as the upstream end. Components, or portions of components, of the aerosol generating article may be described as being upstream or downstream of one another based on their relative positions with respect to the airflow path through the aerosol generating article.

The first and the second filter element may comprise the same materials as the retention material mentioned above. The first and second filter element may avoid any spillover of the active agent and of the gel carrier or the liquid carrier to upstream or downstream parts of the aerosol-generating article.

The first filter element may comprise a non-porous material. This non-porous material may be low-density closed cell foam, for example low-density, low compression set foam of silicon compounds. The low-density closed cell forms may have a density of between 97 to 192 kg/m 3 as determined with ASTM-D-3574. The first filter element also may comprise a porous material. The porous material may comprise cellulose acetate tow. The porous material may also comprise polymers made from natural and sustainable raw material on the basis of acetol made of wood pulp, which is for example marketed under the trademark CERDIA®.

The second filter element may also comprise cellulose acetate tow.

In a further embodiment of the invention the capsule portion of the aerosol-generating article may be wrapped with a capsule wrapper, wherein the capsule wrapper comprises a material which is air-permeable. This may allow air to pass through the capsule wrapper into the capsule portion of the aerosol-generating article. This may further ease the formation of an aerosol including the active agent of the capsule.

The aerosol-generating article may comprise a central longitudinal axis. The aerosol-generating article also may comprise a transverse axis, running perpendicular to the central longitudinal axis. A capsule wrapper comprising an air-permeable material may increase the air flow into the capsule portion along the transverse axis.

The capsule wrapper comprising an air-permeable material may exhibit a basis weight of 9 g/m² to 28 g/m², preferably 11 g/m² to 25 g/m², more preferably 12 g/m² to 24 g/m². The capsule wrapper may have a thickness of between 0.01 to 0.07 millimeters. The capsule wrapper may exhibit a wet bursting strength of at least 350 millimeters water column. The capsule wrapper may exhibit an air permeability of between 80 cm³/cm²·s to 170 cm³/cm²·s, preferably 90 cm³/cm²·s to 160 cm³/cm²·s. The tensile strength in machine direction (MD) may at least be 0.052 kn/m. The tensile strength of the capsule wrapper in cross machine direction (CM) may be at least 0.012 kn/m. The filtering rate for particle retention of the capsule wrapper may be smaller or equal to 5S/8 layers. In particular, the capsule wrapper may comprise material, commonly referred to as “tea bag paper”, which is used for the production of tea bags. The air-permeable capsule wrapper may comprise filter paper.

The aerosol-generating article may only comprise a capsule portion as mentioned above as the only portion of the aerosol-generating article comprising aerosol-forming material for formation of an aerosol. In particular, the aerosol-generating article may only comprise a capsule portion including the retention material as mentioned above and one or more capsules. The aerosol generating article furthermore may comprise the additional first and second filter element included in the capsule portion, as mentioned above. This aerosol-generating article also may comprise the capsule wrapper as described above. The one or more active agents of the one or more capsules also may comprise one or both of nicotine and other flavorants for forming an aerosol.

An aerosol-generating article only comprising a capsule portion may have a diameter of between 4 to 12 millimeters, preferably 5 to 9 millimeters. The length of the aerosol-generating article may be between 8 to 27 millimeters, preferably 10 to 19 millimeters. This length may include the length of the retention material with the one or more capsules also including the first and second filter element. The thickness of both the first and second filter element may be between 3 to 7 millimeters, preferably 4 to 5 millimeters. The length of only the portion of the aerosol-generating article containing the retention material forming a hollow tubular portion may be between 7 to 19 millimeters, preferably 8 to 13 millimeters.

The aerosol-generating article additionally may comprise a substrate portion. The substrate portion may comprise aerosol-forming substrate. The aerosol-generating article therefore may comprise a capsule portion, as mentioned above and additionally a substrate portion.

In one embodiment of the aerosol-generating article the capsule portion may be adjacent to the substrate portion. This may ease the formation of aerosol containing components from both the substrate portion and the capsule portion.

The aerosol-forming substrate of the substrate portion may comprise a plug of formed aerosol-forming substrate. The plug may be a pressed or molded substrate portion containing the aerosol-forming substrate or it may be a pre-packaged substrate portion including a wrapper, such as paper being wrapped around the aerosol-forming substrate. The aerosol-forming substrate may also comprise a gel. The aerosol-forming substrate may comprise a non-volatile carrier material together which one or both of volatile aerosol-formers and one or more active agents which can form part of the aerosol. Examples of non-volatile carrier material may be paper or cotton. The aerosol-forming substrate is a substrate capable of releasing volatile compounds that can form an aerosol. The volatile compounds may be released by heating the aerosol-forming substrate. The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. The aerosol-forming substrate may comprise homogenized tobacco. The aerosol-forming substrate may alternatively comprise a non-tobacco-containing material. The aerosol-forming substrate may comprise homogenised plant-based material.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol.

The capsule portion may be located downstream of the substrate portion in the aerosol-generating article. The capsule portion may be located adjacent to the substrate portion in the aerosol-generating article. This may facilitate incorporating any active agent released upon heating the capsule into an aerosol formed from the aerosol-forming substrate of the substrate portion. The active agent in the capsule in particular may comprise flavorants in order to change the flavor and the user perception when inhaling the aerosol.

The aerosol-generating article may be shaped as a rod. Such a rod-shaped article may easily be received by the cavity of an aerosol-generating device. One or both of the capsule portion and the substrate portion of the aerosol-generating article may be shaped as a rod. Preferably both, the capsule portion and the substrate portion are shaped as a rod.

The one or more active agents contained in the one or more breakable capsules may be solid or liquid. The one or more active agents may comprise a gel. The one or more active agents may be volatile. Containing volatile active agents in the one or more breakable capsules may ensure that the volatile agents do not evaporate before the aerosol-generating article is used.

Alternatively, the aerosol-generating article may comprise aerosol-forming substrate and one or more capsules embedded in the aerosol-forming substrate. The aerosol-forming article therefore may include one combined substrate/capsule portion. When heating the aerosol-forming substrate, one or more active agents of the capsule may be released. The one or more active agents then may form an aerosol together with the components of the aerosol-forming substrate.

The aerosol-generating article may comprise a hollow tubular article portion. The hollow tubular article portion may have a tubular empty core structure. The hollow tubular article portion may be for example a hollow acetate tube (HAT), a fine hollow acetate tube (FHAT) or a plug of tow wrapped around a central cardboard tube, or a tube formed of cardboard all of which structures being known from manufacture of filter elements. The hollow tubular article portion may be located downstream of the capsule portion of the aerosol-generating article. The hollow tubular article portion may serve to cool down the aerosol generated from the substrate portion and the capsule portion of the aerosol-generating article.

If desired or required, for example to achieve a sufficiently high resistance to draw of the aerosol-generating article, an additional filter portion may be included in the aerosol-generating article. Preferably such additional filter portion may be included downstream of the substrate portion and the capsule portion. If the hollow tubular article portion is also included in the aerosol-generating article, the filter portion may be located downstream of the hollow tubular article portion. Preferably, such additional filter portion comprises a filtration material such as, for example, cellulose acetate.

The invention also provides an aerosol-generating system which may comprise an aerosol-generating device, which may comprise a cavity and a heating element. The aerosol-generating system also may comprise an aerosol-generating article as described herein. The heating element of the aerosol-generating device may comprise an induction heating element configured for generating an alternating magnetic field.

Also provided is an aerosol-generating system which comprises an aerosol-generating device including a cavity and a heating element. The aerosol-generating system also comprises an aerosol-generating article as described herein. The cavity of the aerosol-generating device is configured to receive said aerosol-generating article. The heating element of the aerosol-generating device comprises an induction heating element configured for generating an alternating magnetic field.

The active agent included in one or more capsules located in the capsule portion of the aerosol-generating article may be released when heating the aerosol-generating article received in the cavity of the aerosol-generating device. Upon heating of the aerosol-generating article with the heating element, an aerosol may be formed from the aerosol-forming substrate and the one or more active agents.

The heating element may be an induction heating element. For induction heating, the heating element preferably comprises an induction coil. An alternating current may be supplied to the induction coil for generating an alternating magnetic field. The alternating current may have a high frequency. As used herein, the term “high frequency oscillating current” means an oscillating current having a frequency of between 500 kilohertz and 30 megahertz. The high frequency oscillating current may have a frequency of from about 1 megahertz to about 30 megahertz, preferably from about 1 megahertz to about 10 megahertz and more preferably from about 5 megahertz to about 8 megahertz.

The heating element may be configured to heat the aerosol-generating article to a temperature ranging from 220 degrees Celsius to 400 degrees Celsius, preferably from 250 degrees Celsius to 290 degrees Celsius.

The cavity of the aerosol-generating device may be configured as a heating chamber. The cavity may have a cylindrical shape. The cavity may have a hollow cylindrical shape. The cavity may have a shape corresponding to the shape of the aerosol-generating article to be received in the cavity. The cavity may have a circular cross-section. The cavity may have an elliptical or rectangular cross-section. The cavity may have an inner diameter corresponding to the outer diameter of the aerosol-generating article.

An airflow channel may run through the cavity. Ambient air may be drawn into the aerosol-generating device, into the cavity and towards the user through the airflow channel. Downstream of the cavity, a mouthpiece may be arranged or a user may directly draw on the aerosol-generating article. The airflow channel may extend through the mouthpiece.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The aerosol-generating device may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating element, particularly to the induction coil. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The aerosol-generating device may comprise a power supply, typically a battery, within a main body of the aerosol-generating device. The power supply may be configured in order to operate at the frequencies mentioned above. This may provide the alternating current for generating the alternating magnetic field. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

One or both of the power supply and the electric circuitry may be configured in order to provide an alternating current to the inductive heating element. The alternating current may induce an alternating magnetic field in the susceptor particles leading to a heating of the susceptor particles. The alternating magnetic field also may induce a magnetorheological effect in the susceptor particles. This may lead to an agglomeration and to the formation of clusters which may ease the release of the one or more active agents from the capsule.

It also may be possible to first apply an alternating current to the inductive heating element for heating the susceptor particles. This may liquefy any carrier gel present in the capsule. Furthermore, the viscosity of a carrier liquid present in the capsule may also be reduced upon heating. In a second step, a direct current may be applied to the inductive heating element so that a constant magnetic field is applied to the capsule. Such a constant magnetic field may increase the magnetorheological effect and therefore the clustering and the formation of aggregates in the capsule.

One embodiment of the invention also may provide a method of operating an aerosol-generating system, the system being as described herein. The method may comprise the method steps of:
receiving the aerosol-generating article in the cavity of the aerosol-generating device, and
heating the aerosol-generating article by the induction heating element, thereby releasing the one or more active agents from the capsule.

The method may employ an aerosol-generating article, which apart from a capsule section mentioned herein also may comprise a substrate section as described above. Heating the aerosol-generating article by the induction heating element then may lead to the formation of an aerosol including components of the aerosol-forming substrate from the substrate portion and including the one or more active agents from the capsule portion of the aerosol-generating article.

Below, there is provided a non-exhaustive list of non-limiting examples. Any one or more of the features of these examples may be combined with any one or more features of another example, embodiment, or aspect described herein.

Example A: A capsule for use in an aerosol generating article, the capsule comprising:
an active agent,
susceptor particles, and
one or both of a carrier gel or a carrier liquid,
wherein the susceptor particles are dispersed in the one or both of the carrier gel or the carrier liquid.

Example B: The capsule according to Example A, wherein the one or both of the carrier gel or the carrier liquid comprises one or more of:
at least one polyhydric alcohol,
at least one ester of a polyhydric alcohol, and
at least one aliphatic ester of a mono-, di- or polycarboxylic acid.

Example C: The capsule according to any of the preceding examples, comprising a carrier gel, wherein the carrier gel comprises a gelling agent.

Example D: The capsule according to any of the preceding examples, wherein the susceptor particles are ferromagnetic.

Example E: The capsule according to any of the preceding examples, wherein the susceptor particles comprise a metal or metal oxide.

Example F: The capsule according to any of the preceding examples, wherein the susceptor particles have a particle size of about 10 μm to 70 μm.

Example G: The capsule according to any of the preceding examples, wherein the susceptor particles are present in an amount of 5 to 45 weight percent.

Example H: The capsule according to any of the preceding examples, further comprising fibers.

Example I: The capsule according to any of the preceding examples, further comprising a C₃ to C₆ alkyl hydroxy carboxylic acid.

Example J: The capsule according to any of the preceding examples, wherein the active agent comprises one or more of flavorants, nicotine and medications.

Example K: The capsule according to any of the preceding examples, comprising a shell, the shell encapsulating the active agent, the susceptor particles, and the one or both of a carrier gel or a carrier liquid.

Example L: The capsule according to any of the preceding examples, comprising a carrier liquid, the carrier liquid and the susceptor particles forming a magnetorheological fluid.

Example M: An aerosol-generating article comprising a capsule according to any of the preceding examples.

Example N: The aerosol-generating article according to Example M, comprising a capsule portion containing a retention material, wherein said capsule is located adjacent to the retention material in the capsule portion.

Example O: The aerosol-generating article according to Example N, wherein the retention material comprises filter material.

Example P: The aerosol-generating article according to any of the Examples M to wherein the capsule portion comprises a first filter element, being located upstream of the capsule and a second filter element being located downstream of the capsule.

Example Q: The aerosol-generating article according to any of the Examples M to P, wherein the capsule portion is wrapped with a capsule wrapper, the capsule wrapper comprising a material which is air-permeable.

Example R: The aerosol-generating article according to any of the Examples M to Q, further comprising aerosol-forming substrate.

Example S: Aerosol-generating system, comprising
an aerosol-generating article according to any of the Examples M to R, and
an aerosol-generating device, the aerosol-generating device including a cavity, wherein the cavity is configured to receive said aerosol-generating article, and an induction heating element.

Example T: A method of operating an aerosol-generating system according to Example S, comprising the method steps of:
receiving the aerosol-generating article in the cavity of the aerosol-generating device,
heating the aerosol-generating article by the induction heating element, thereby releasing the active agent from the capsule.

Features described in relation to one embodiment may equally be applied to other embodiments of the invention.

The invention will be further described, by way of example only, with reference to the accompanying drawings in which:

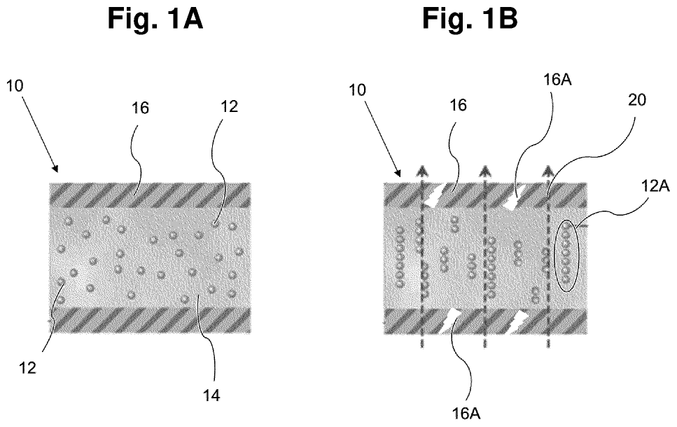

FIG. 1A shows a cross-sectional view of a part of a capsule without a magnetic field applied;

FIG. 1B shows a cross-sectional view of a part of a capsule with a magnetic field applied;

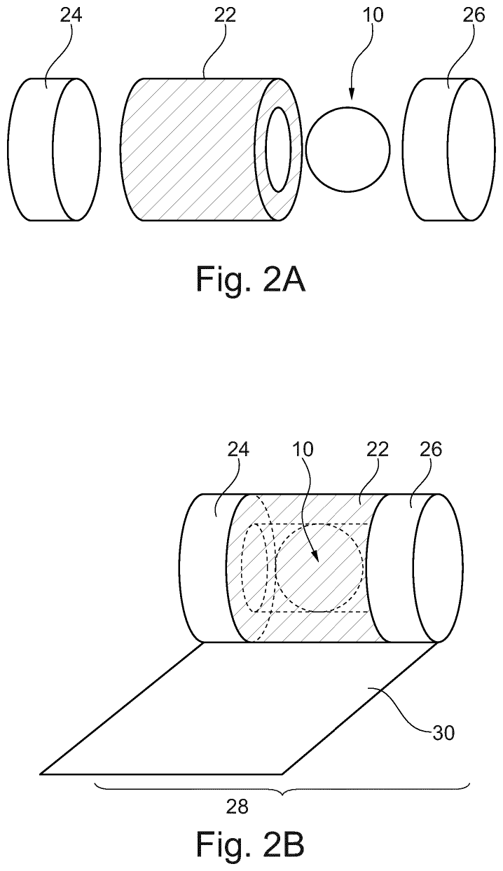

FIG. 2A shows an exploded view of a capsule portion;

FIG. 2B shows a perspective view of the capsule portion shown in exploded view in FIG. 2A;

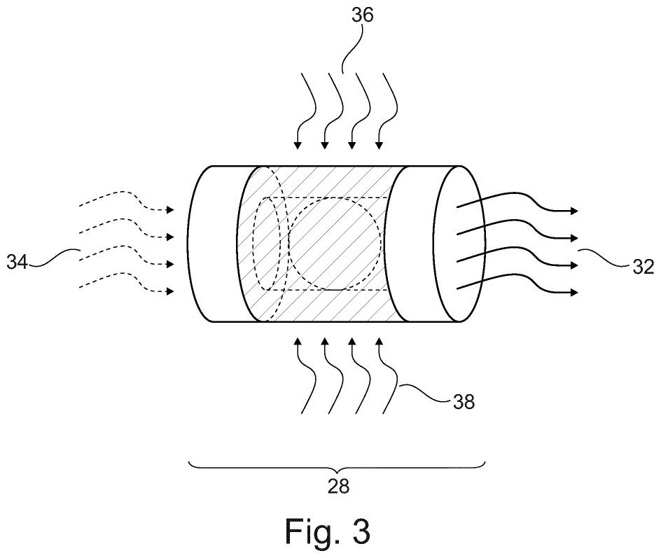

FIG. 3 shows the different directions of the air flow into a capsule portion in accordance with one embodiment of the present invention.

In the following the same elements are marked with the same reference numerals throughout all the figures.

FIG. 1A depicts a cross-sectional view of a part of a capsule 10. A shell 16 encapsulates a gel carrier or a liquid carrier 14 and susceptor particles 12 dispersed in the gel carrier or the liquid carrier. In the absence of a magnetic field, the susceptor particles are uniformly dispersed within the gel carrier or the liquid carrier. One or more active agents (active agents not shown in the Fig.) are dissolved in either the gel carrier or the liquid carrier.

FIG. 1A shows a cross-sectional view of the part of the capsule 10 shown in FIG. 1A after an alternating magnetic field 20 has been applied to the capsule. The magnetic field lines 20 lead to the formation of clusters 12A of the susceptor particles 12 along the magnetic field line 20 in the either liquefied gel carrier or in the liquid carrier. Additionally, the shell of the capsule 10 becomes permeable for the fluid after heating of the susceptor particles in an alternating magnetic field, as indicated by the breakup regions 16A of the shell. Channels are formed between the clusters of the susceptor particles which also ease the release of the one or more active agents dissolved in the liquid carrier or the gel carrier. Thus, applying an alternating magnetic field to the capsule leads on the one hand to the heating of the susceptor particles due to the induction of eddy currents or hysteresis losses and on the other hand also enables the formation of clusters or aggregates of the susceptor particles. Both effects greatly ease the release of the one or more active agents from the capsule without need to apply any mechanical pressure in order to break the capsule.

FIG. 2A depicts an exploded view of a capsule portion 28. A capsule 10 is shown, which is to be embedded within a hollow tubular portion 22 of the retention material. The retention material is supposed to absorb any liquid carrier material or any liquefied gel carrier material and any active agents released from the capsule upon heating of the capsule. Upstream of the hollow tubular portion 22 a first filter element 24 and downstream a second filter element 26 are present. These filter elements also absorb any liquefied gel carrier or liquid carrier and active agent.

FIG. 2B shows the assembled elements of the capsule portion 28 including the capsule 10 surrounded by the hollow tubular portion 22 of the retention material as shown in FIG. 2A. The complete capsule portion is wrapped in a capsule wrapper 30, which preferably comprises an air-permeable material. Such a capsule portion 28 may be the only portion of an aerosol-generating article including the capsule. Alternatively, additional portions may be present in the aerosol-generating article, such as a substrate portion including aerosol-forming substrate.

FIG. 3 depicts different air flow paths through the capsule portion 28. Air can penetrate the capsule portion 28 from upstream, shown by the reference numeral 34 and can leave the capsule portion 28 downstream of the capsule portion (shown with the reference numeral 32). If the capsule wrapper comprises an air-permeable material, an additional lateral airflow 36, 38 is possible, which eases the formation of an aerosol including at least the active agent of the capsule.

1.-14. (canceled)

15. A capsule for an aerosol generating article, the capsule comprising:
an active agent;
susceptor particles configured to be heatable upon inductive heating; and
one or both of a carrier gel or a carrier liquid,
wherein the susceptor particles are dispersed in the one or both of the carrier gel or the carrier liquid, and
wherein the susceptor particles have a particle size of about 10 μm to 70 μm.

16. The capsule according to claim 15, wherein the one or both of the carrier gel or the carrier liquid comprises one or more of:
at least one polyhydric alcohol,
at least one ester of a polyhydric alcohol, and
at least one aliphatic ester of a mono-, di-, or polycarboxylic acid.

17. The capsule according to claim 15,
further comprising a carrier gel,
wherein the carrier gel comprises a gelling agent.

18. The capsule according to claim 15, wherein the susceptor particles are ferromagnetic.

19. The capsule according to claim 15, wherein the susceptor particles are present in an amount of 5 weight percent to 45 weight percent.

20. The capsule according to claim 15, further comprising fibers.

21. The capsule according to claim 15, wherein the active agent comprises one or more of flavorants, nicotine, and medications.

22. The capsule according to claim 15, further comprising a carrier liquid, the carrier liquid and the susceptor particles forming a magnetorheological fluid.

23. An aerosol-generating article comprising a capsule according to claim 15.

24. The aerosol-generating article according to claim 23,
further comprising a capsule portion containing a retention material,
wherein the capsule is located adjacent to the retention material in the capsule portion.

25. The aerosol-generating article according to claim 24, wherein the capsule portion comprises a first filter element located upstream of the capsule, and a second filter element located downstream of the capsule.

26. The aerosol-generating article according to claim 24, wherein the capsule portion is wrapped with a capsule wrapper, the capsule wrapper comprising a material that is air-permeable.

27. An aerosol-generating system, comprising
an aerosol-generating article according to claim 23;
an aerosol-generating device including a cavity, wherein the cavity is configured to receive the aerosol-generating article; and
an induction heating element.

28. A method of operating an aerosol-generating system according to claim 27, the method comprising the steps of:
receiving the aerosol-generating article in the cavity of the aerosol-generating device; and
heating the aerosol-generating article by the induction heating element, thereby releasing the active agent from the capsule.
